(19) United States
(12) Patent Application Publication
(10) Pub. No.: US 2016/0210686 A1
(43) Pub. Date: Jul. 21, 2016

(54) SYSTEM AND METHOD OF CAPTURING, MANAGING AND DISTRIBUTING DIGITAL IMAGE GOODS AND SERVICES

(71) Applicant: ImageQuix, Inc., Greer, SC (US)

(72) Inventor: Mark Valente, Greer, SC (US)

(73) Assignee: ImageQuick, Inc., Greer, SC (US)

(21) Appl. No.: 15/003,355

(22) Filed: Jan. 21, 2016

Related U.S. Application Data
(60) Provisional application No. 62/105,797, filed on Jan. 21, 2015.

(51) Int. Cl. G06Q 30/06; G06T 1/00; G06F 3/0482; G06F 17/30

(52) U.S. Cl. CPC G06Q 30/0635; G06F 17/3028; G06F 17/30265; G06T 1/0007; G06F 3/0482; G06T 2200/24

(57) ABSTRACT

This invention is directed to a computer-implemented system for capturing, managing, storing, and distributing goods and services related to photographic digital images, the system comprising: a server; a set of gallery information stored on the computer readable medium of the server, a set of server computer readable instructions configured to: receive a sync digital image, receive a set of digital images each having a digital image timestamp, receive a portable sync timestamp and a set of subject description selection information from a portable computer device, calculate a synchronizing offset, interlace the subject timeline with the image timeline and sequentially realigning the timelines, assign subject descriptors in temporal order with digital images.

### FIELD OF THE INVENTION

This invention is directed to a system and method for capturing, managing, and distributing digital images goods and services.

### BACKGROUND

Photography is a common and long standing method of memorializing events and capturing and storing memories. An entire industry has developed that includes photographers capturing images, creating image products such as photographs, slides shows, and imprinting images on goods such as coffee cups, plaques, t-shirts, and the like. With the advent of digital images, this industry has grown to a multibillion dollar a year industry according to one market research company. (IBIS World October 2014, Photography Market Research Report).

With the advent of the digital imaging and global communication networks, purchasers of digital image goods and services that can order online, customize goods, and have such goods shipped to a location of their choice. Goods that can include a digital image are cards, calendars, canvas prints, wall art, ornaments, cups, mugs, mouse pads, plates, coasters, clothing, magnets, stationary, pillows, blankets, and many others. Such goods are generally provided by both the professional photographer as well as third party vendors. Additionally, the digital image can be provided to the customer allowing the customer to use the image in any number of ways. It would be advantageous to allow a photographer to provide various goods and services to a customer in a seamless online interface while reducing the administrative tasks required by the photographer.

For example, the tradition of the school photo has been around since at least the early 1930s. Organizing and taking school photos is a logistically intensive process; from the gathering of the identification data of the photo subjects, to taking the images, to distributing these to schools, yearbooks distributors as well as the individuals themselves. The business model that has developed over the years includes one where the photographer generates revenues by providing the photographic service for little to no fee but offers the prints from the digital images to the students, or more accurately, the students' parents for a fee.

Image Identification and Matching

One challenge to this process is to match the digital image taken at the school with the correct student. For example, students could hold a sign or paper with their name, grade, and class for the first image taken so that the photographer can simply review the first image of the set for that subject and receive the identification information. This process requires a significant amount of time in that each photograph has to be reviewed and associated with the subject's information.

In an alternative process, a list of the students (photographic subjects) are provided to the photographer. The students are placed in line and in order as shown in the list. The images are taken in the same order as that of the list. Subsequently, the photographer reviews the images and associates the images with the subject's information with the assumption that the images are in order of the list. This process has significant disadvantages in that if the photographic subjects are out of order then it is virtually impossible to associate the subject's information with the images. The photographic subject can become out of order if they physically move in the line or one is absent.

U.S. Pat. No. 7,215,833 is a method for correlating and assigning digital camera images to a database file. However, this invention uses a timestamp from a bar code reader to synchronize recorded swipes of bar codes with the digital images created produced by the camera. Therefore, specialized equipment is needed and there must be synchronization between the specialized equipment, the bar code reader, and the camera.

With the traditional methods of matching names with images, automating the process was challenging at best. For example, to automatically match the list of names with the images through a computer method would require some additional steps or limitations. In one case, the photographer would take a fixed number of images per subject, (e.g. two and only two) so that each name on the list would be associated with the predetermined number of images. Alternatively, a computer system could use facial recognition technology to match images and associate like images with the subject's information. Neither method is desirable.

Workflow

With the acceptance of digital technology in the photography industry and integration of the digital photographer with the goods offered that are associated with digital images, the workflow has become unmanageable for high volume photographers. Traditionally, the photographer would need to schedule with each establishment (e.g. school) a time for taking hundreds if not thousands of photographs. The logistics associated with the photographic session itself would have to be handled. Product offerings would have to be coordinated with third party vendors prior to each session to provide potential customers with potential goods to purchase. The digital images, once captured, have to be stored and organized based upon entities (such as schools). It would be desirable to have an online point of sale system that can be managed by the photographer without needing a third party. This way the online point of sale system can be much easier managed and costs can be avoided by the photographer. Once images are captured, editing may be needed. Data received, such as a list of students needs to be managed and reviewed for errors and the like. The images need to be provided to potential customer, but limited in access so that all customers cannot review all images. Management of ordered products needs to be coordinated between the photographer's products offered, and those that are sourced to third party vendors. Financial transactions need to be managed so that payments are made to the correct entities. Reporting having strategic value needs to be offered so that adjustment to prices, packages, product mix, margins, and the like, can be adjusted in the hopes of maximizing profits.

Accordingly, it is an object of the present invention to provide for a seamless interface for photographers to capture images, manage the images, display the image to potential customer, and provide a seamless interface to customers to select and order digital image goods and services.

It is an object of the present invention to allow a photographer to create online customized ordering information for each photographic project and allow customers to select goods and services from the seamless interface without regard to the vendor of the good or service.

It is an object of the present invention to allow a photographer to create an online system to seamlessly manage the photographic process of digital image capture, management, and distribution.

### BRIEF DESCRIPTION OF THE DRAWINGS

The invention is further described in reference to the following drawings which are incorporated by reference.

FIG. 1 is a schematic of components of the invention;

FIG. 2A through 2C are diagrams of aspects and the operation of the present invention; and,

FIGS. 3 through 5 are flowcharts of the present invention;

FIG. 6A is a diagram of aspects of ordering interface the invention;

FIG. 6B is a screen showing aspects of the invention;

FIG. 7 is a schematic of components of the invention;

FIG. 8 is a schematic of components of the invention with a screen shot of aspects of the invention; and,

FIG. 9 is a schematic of components of the invention.

### SUMMARY OF THE INVENTION

The construction designed to carry out the invention will hereinafter be described, together with other features thereof. The invention will be more readily understood from a reading of the following specification and by reference to the accompanying drawings. The objects of the invention are accomplished by providing a system for photographic job creation and administration comprising: a server having a computer readable instructions that when executed by the processor, performs the steps of: initializing a job, creating a product offering associated with the job; storing the subject matter indicators in a database, receiving subject matter identifiers from the entity requesting the job, scheduling a job including retake dates and times; capturing images using timestamp synchronization (smart tag); receiving pre-order information in a smart phone in communications with the server; editing the publishing of the images; receiving orders for digital goods online from customers; sending order information to fulfillment vendors for delivery to the customers and providing reports concerning metrics including buy rates, profits, order timing, and any combination thereof.

The invention can include a server having a computer readable medium and a processor; a set of server computer readable instructions that, when executed by the processor, are configured to: receive a set of subject descriptors from an originating remote computer in communications with the server wherein the set of subject descriptors include properties taken from a group consisting of: name; school; grade; class; teacher; and any combination thereof, create gallery information representing different photographic jobs, associate each subject descriptor with a particular gallery, receive a sync digital image having a sync digital date and time created from a digital image capturing device, stored on a digital image capturing device media and receive a set of digital images each having a digital image timestamp wherein the sync digital image and set of digital images are configured in temporal order to define an image timeline, receive a portable sync timestamp and a set of subject descriptors selection information from a portable computer device, calculate a synchronizing offset between the sync timestamp and the sync digital date and time, interlace the subject timeline with the image timeline and sequentially realigning the subject timeline with the image timeline according to the synchronizing offset, assign subject descriptors in temporal order with digital images according to the realigned interlaced subject timeline and image timeline, transmit the digital images with assigned subject descriptors to a fulfillment computer system configured to produce digital image goods transmitted to the purchaser.

A portable computer device can be included having a portable processor and a set of portable computer readable instructions that, when executed by the portable processor, are configured to: receive a listing of galleries from the server, display the list of galleries to a photographer, receive a gallery selection from the photographer, receive a subset of subject descriptors associated with the selected gallery, display at least a portion of the subset of subject descriptors to the photographer, capture the portable sync timestamp, receive a set of subject description selection information from the photographer having descriptor selection timestamp, transmit the portable sync timestamp and the subject description selection information to the server; and, wherein the subject timeline is defined by the portable sync timestamp and set of subject descriptor selection information configured in a temporal arrangement.

The set of server computer readable instructions can be are configured to: receive a second image timeline, calculate a synchronizing offset between the sync timestamp and the sync digital date and time, calculate a second synchronizing offset between the sync timestamp and a second sync digital date and time included in the second image timeline, interlace the subject timeline, image timeline and second image timeline and sequentially realigning the subject timeline with the image timeline and second image timeline according to the synchronizing offset and second synchronizing offset, assign subject descriptors in temporal order with digital images according to the realigned interlaced subject timeline, image timeline and second image timeline, and, transmit the digital images with assigned subject descriptors to a fulfillment computer system configured to produce digital image goods transmitted to the purchaser.

The set of server computer readable instructions are configured to calculate the synchronizing offset by converting the sync timestamp and the sync digital date and time into POSIX and calculating the difference between the sync timestamp and the sync digital date and time. The set of server computer readable instructions are configured to: calculate brackets between adjacent subject descriptors, and, assign subject descriptors in temporal order with digital images according to the realigned interlaced subject timeline, image timeline and the brackets.

The set of server computer readable instructions are configured to: receive a fulfillment request from a user, and, transmit the fulfillment request to the fulfillment computer system. The sync digital image can be a digital image that is nearly black; and the set of server computer readable instructions are configured to detect a nearly black digital image and determine the sync digital date and time from the nearly black digital image. The set of server computer readable instructions are configured to: receive purchaser user information representing a potential purchaser of digital goods or services, associate a gallery to the purchase user information, associate a subject descriptor to the user representing a digital image subject, and, transmitting to a purchaser's computer digital images and goods and services associated with the digital images matching the gallery and subject descriptor associated with the purchaser.

The set of server computer readable instructions are configured to: receive fund information that represents funds to be received from the purchaser, calculate a predetermined portion of the fund total from the total amount received from the purchaser, and, transmit the fund information less the predetermined portion of the fund total to the fulfillment computer system. The set of portable computer readable instructions are configured to: receive goods information from the server, display goods for purchase to the user associated with the selected subject descriptor, receive purchase information from the user, and, transmit the purchase information to the server.

The invention can include a set of gallery information stored on the computer readable medium wherein each gallery includes a set of subject descriptors stored on the computer readable medium; a set of server computer readable instructions that, when executed by the processor, are configured to: receive a sync digital image having a sync digital date and time created from a digital image capturing device and stored on a digital image capturing device media, receive a set of digital images stored on a digital image capturing device media each having a digital image timestamp wherein the sync digital image and set of digital images are configured in temporal order to define an image timeline, receive a portable sync timestamp and a set of subject descriptor selection information from a portable computer device, calculate a synchronizing offset between the sync timestamp and the sync digital date and time, receive a subject timeline defined by the portable sync timestamp and set of subject descriptor selection information configured in a temporal arrangement, interlace the subject timeline with the image timeline and sequentially realigning the subject timeline with the image timeline according to the synchronizing offset, assign subject descriptors in temporal order with digital images according to the realigned interlaced subject timeline and image timeline, transmit the digital images with assigned subject descriptors to a fulfillment computer system configured to produce digital image goods transmitted to the purchaser.

The brackets can be defined as the difference between the descriptor selection timestamp of one of the subject descriptors and a value less than the timestamp of an adjacent subject descriptors.

The set of server computer readable instructions can be configured to (a) display at least a portion of the subset to the user, (b) receive a set of subject description selection information from the photographer, repeat (a) and (b) until end session information is received from the user.

The brackets can be defined as the difference between the descriptor selection timestamp of one of the subject descriptors and a value less than the timestamp of an adjacent subject descriptors without an intervening digital image in the interlaced subject timeline and the image timeline.

### DESCRIPTION OF THE INVENTION

Computer readable instructions, when executed by a computer processor, cause the computer to perform a series of steps to accomplish a specific task and resulting in useful, concrete, and tangible results. This computer readable code is tied to a particular machine or apparatus with the specific purpose of executing the computer readable code for accomplishing tangible results and represents and accomplishes the manipulation of physical data.

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result, when executed by a computer and its processor representing or resulting in the tangible manipulation of physical objects. These steps also require physical manipulations of physical quantities such as electrical or magnetic physical elements and are capable of being stored, transferred, combined, compared, or otherwise manipulated readable medium that is designed to perform a specific task or tasks. Actual computer or executable code or computer readable code may not be contained within one file or one storage medium, but may span several computers or storage mediums. The term “host” and “server” may be hardware, software, or a combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or codes.

Elements of the flowchart support combinations of means for performing the special functions, combination of steps for performing the specified functions, and program instruction means for performing the specified functions. It will be understood that each block of the flowchart illustrations can be implemented by special purpose hardware-based computer systems that perform the specified functions, steps, or combinations of special purpose hardware or computer instructions.

As illustrated by the claims below, the present invention, while implemented in a computer system, is a specific invention distinct from the types of concepts found by the courts to be abstract. The invention provides a solution while implemented with digital capture devices and computers, overcomes a problem specifically arising in the realm of digital photography, especially problems that arise with a multiple session, by multiple photographers, a multiple subjects taken in volume. By tying the operation of the invention to the computer's ability to process digital images, meaningful limitations are provided that improve the functioning of the computer itself by allowing organizational temporal timelines that improved the technology and industry over previous techniques.

The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough, complete, and will fully convey the scope of the invention to those skilled in the art.

Smart Capture

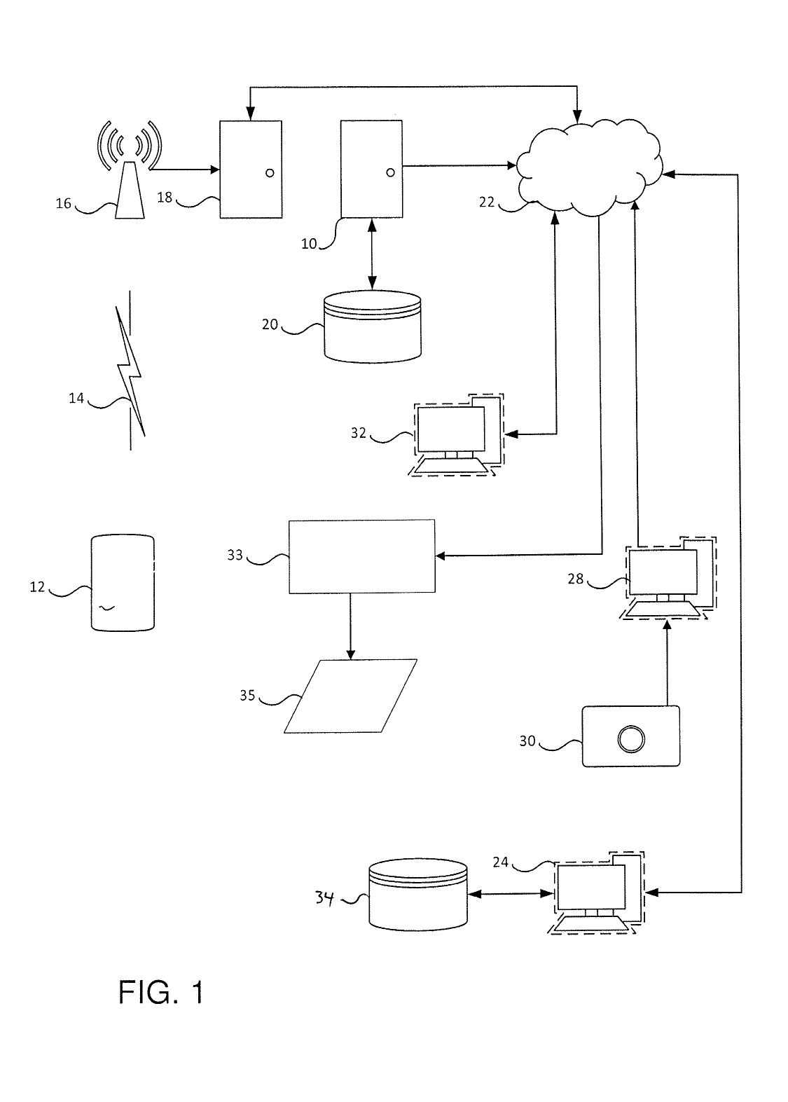

Referring to FIG. 1, a server 10 has a computer readable medium and a processor. The service is in electronic communication 14 with a portable computing device having processor and computer readable instructions such as a smart phone 12 through a wireless network such as a cellular network. The wireless network can include an access point 16 that is connected to a wireless server 18 which in turn can be connected to the server. With this configuration, the smart phone can be in real time communication with the server and can transmit and receive digital information to and from the server in real time. The wireless server and the server can be connected through a wide area network 22 such as a global communications network. The smart phone can include a processor, digital storage, camera, and display.

The portable computer device, such as a smart phone, can include computer readable instructions that when executed by a portable processor included in the portably computer device are configured to: receive a listing of galleries from the server, display the list of galleries to a photographer, receive a gallery selection from the photographer, receive a subset of subject descriptors associated with the selected gallery, display at least a portion of the subset of subject descriptors to the photographer, capture the portable sync timestamp, receive a set of subject description selection information from the photographer having descriptor selection timestamp, transmit the portable sync timestamp and the subject description selection information to the server

A subject database 20 can be included in the server computer readable medium or can be stored remotely from the server and in communication with the server. The database can include a set of records that are subject descriptors that represent subjects that are to be photographed. For example, the subject descriptors can include a unique subject identifier, name, school, grade, teacher, and the like. The unique identifier can be a computer readable symbol, barcode, QR code, or alpha numeric text. The set of subject descriptors can originate from a remote computer in communications with the server such as from a school, athletic program or other source that maintains a list of the students or photographic subjects. The subject descriptors can include contact information for individual associated with the subjects such as parents, teachers of coaches. Contact information for these associated individuals can be included so that digital image goods can be marketed to the associated individuals

The server can include a set of computer readable instructions stored on the server computer readable medium that when executed by a processor included with the server receives a list of the subject descriptors from a third party such as a school. The third party can use a remote computer 24 connected to the wide area network to send the list of subject descriptors to the server. For example, a school can send a list of the students attending the school so that subjects for photographs are provided to the photographer prior to the photographer arriving at the school to take the photographs. In one embodiment, the subject descriptors can be uploaded in a database or dataset format 34. When the server receives lists of subject descriptors, the server can populate a subject database with the list of subject descriptors. The particular list can be identified by school, grade, teacher, and the like. Further, the photographer can determine the number of sessions or cameras that will be needed based upon the volume of photographs that are needed to be taken. A gallery can be defined and identified with a gallery identifier and also associated with a list of subject descriptors. The subject descriptors can be associated with a particular gallery or multiple galleries. For example, a gallery can be all the students in a school. In one embodiment, information that can be associated with a gallery includes the gallery identification which can be alpha numeric text, date the gallery was created, the status of the gallery (active or inactive), password to access the gallery, keywords associated with the gallery, the number of images contained within the gallery, the number of times the gallery was viewed and the number of different subjects contained in the gallery. The gallery descriptors or gallery name or gallery identification can be transmitted to the smart phone so that the photographer can select the gallery to be associated with the photography session.

In one embodiment, the subjects in the gallery can be listed. For example, the name of the students can be listed that are associated with the selected gallery and displayed on the smart phone. Further, information such as who has ordered images from the gallery and the amount that has been received for each order can be displayed on the smart phone. Once a group is selected, the subject is selected from the group, and the images are captured. The groups and potential sub-groups, can be selected at the job creation described below.

The photographer is also able to record notes that will be included with the subject during the image capture process so that the note information is available for subsequent review.

During a photographic session, the photographer uses the smart phone and executes computer readable instructions located on the smart phone. The computer readable instructions can allow the photographer to log in with a unique photographer identification. The photographer identification can be transmitted to the server and authenticated.

The photographer can then select a new session from the smart phone indicating that a new photographic session is desired. The photographer can then provide a camera label to identify a digital camera that will be associated with the session. The camera label can be an alpha numeric text. The camera label can be transmitted to the server.

The server can transmit gallery identifiers, and other gallery information, from the server to the smart phone that is associated with the particular photographer. The smart phone can then display the list of galleries to the photographer and the photographer can select which gallery to work with for the particular photography session. When the gallery is selected by the photographer, the gallery identifier can be transmitted to the server so that the server is provided the information to determine which gallery the photographer is working with.

With the gallery information, the server can transmit the subject descriptors to the smart phone and the list of subjects can be displayed on the smart phone to the photographer.

In one embodiment, a sync step is performed. In this step, the photographer actuates the smart phone to create a sync timestamp while simultaneously taking a picture with the lens cap on the camera. The sync timestamp can be transmitted to the server.

The next step, the photographer will capture the subject identification of the first photographic subject. In one embodiment, the subjects are provided with an identifier that can be alpha numeric text, barcode, QR code, number, and the like. The subject descriptor is included in the subject descriptors. The smart phone can capture the subject descriptor through the smart phone camera or other input from the photographer. For example, the subject can present a subject descriptor to the photographer and the subject descriptor is captured by the smart phone. The smart phone can retrieve the subject's name from the subject descriptors associated with the subject descriptor and display the name to the photographer so that the photographer can verify that the subject physically has the proper subject descriptor. The subject descriptor can be transmitted to the server when verified. If the subject descriptor is not correct, the subject descriptor can be corrected and captured by the smart phone again and transmitted to the server. Once the subject descriptor is captured, the photographer can then take digital images of the subject.

When the photographer wishes to move to the next subject, the photographer captures the next subject descriptor and takes digital images of the next subject. These steps are repeated until a termination event occurs such as all subjects are taken. When the session is ended as can be indicated by the photographer on the smart phone, the smart phone can display the gallery information and the number of subjects that were captured. This can assist the photographer with ensuring that all subjects were captured. In one embodiment, the subject indicators, and their respective timestamps, are stored on the smart phone and are not uploaded to the server until the session is ended. In one embodiment, the subject indicators cannot be uploaded until the session is associated with a gallery.

In one embodiment, there is eliminated the need for the subject to have a system generated subject descriptor. This embodiment is particular useful for the school environment. The school can provide a list of students for each class and each grade. The list can be imported into a database accessible by the photographer such as by associating the list with the photographer's account and storing the database on the server. When the photographer is ready to visit the school to capture digital images, the photographer downloads the list of names to the smart phone. The photographer can then select the school, grade, and class for the next group of subjects (students and/or teachers). When taking the digital images, the photographer simply asks the next subject their name and selects the name from a list displayed on the smart phone and selects from a list of subject descriptors. The selection results in subject descriptors selection information received from the portable computer device. The smart phone associates a timestamp with the subject's name and stores the information to upload to the server. In one embodiment, a pre-assigned identifier can be used in place of the subjects name such as last four digital of the social security number, school identification number and the like. In this embodiment, the photographer can change the school, grade and class on demand so that it is not necessary to group the subject in any particular order other than for logistical purpose related to school scheduling.

The photographer can then upload the images to the server using the photographer's computer 28. A media card that is removable from the camera can be inserted into the photographer's computer and the images transmitted to the server. In one embodiment, the camera 30 can be connected to the photographer's computer to transmit the digital images to the server.

When transmitting the images to the server, the photographer is presented with a list of galleries associated with that photographer. The photographer selects the desired gallery. The photographer is then presented with a camera label. The photographer selects the camera label associated with the camera used to take the digital images to be transmitted. Therefore, the digital images that are uploaded are associated with a gallery and camera. The server can then determine the proper set of subject indicators that have been previously uploaded that are to be associated with the set of digital images.

Once the digital images have been uploaded, the server's computer readable instructions retrieve the sync timestamp associated with the set of digital images and the timestamp of the sync digital image. A synchronizing offset is calculated by determining the difference between the sync timestamp and the timestamp of the sync digital image or sync digital date and time associated with the sync digital image. In one embodiment, the sync digital image can be analyzed and verified that it is a generally or nearly a black image. For example, if the timestamp is in the format YYYY-MM-DDThh:mm:ss.sTZD where YYYY=four-digit year, MM=two-digit month (01=January, etc.), DD=two-digit day of month (01 through 31), hh=two digits of hour (00 through 23) (am/pm NOT allowed), mm=two digits of minute (00 through 59), ss=two digits of second (00 through 59), s=one or more digits representing a decimal fraction of a second and TZD=time zone designator (Z or +hh:mm or −hh:mm), the timestamp can be converted into POSIX time. When the sync timestamp and the sync digital image timestamp are converted into POSIX time, the difference between the two numbers is in seconds. Therefore, the difference between these two numbers could be the synchronizing offset.

In one embodiment, the next step would be to determine the POSIX number associated with the first images and to adjust the timestamp of the first image by the synchronizing offset. If the adjusted timestamp of the first image is equal to or greater than the timestamp of the first subject descriptor and less than the timestamp of the second subject descriptor, the digital image is associated with the first subject descriptor. By determining brackets defined by the time span between the timestamp of a subject descriptor and the timestamp of the subsequent subject descriptor and associating digital images that have adjusted timestamps in the brackets, the digital images can be associated with a subject descriptor. The brackets can be defined as the difference between adjacent subject descriptors and the subject descriptors in temporal order can be assigned to digital images according to the realigned interlaced subject timeline, image timeline and the brackets. In one embodiment, the brackets can be defined as the difference between the descriptor selection timestamp of one of the subject descriptors and a value less than the timestamp of an adjacent subject descriptors without an intervening digital image in the interlaced subject timeline and the image timeline. As this association can be automated by the server, the photographer need only upload the images and associate the images with a gallery and camera and the images are automatically matched with a subject descriptor.

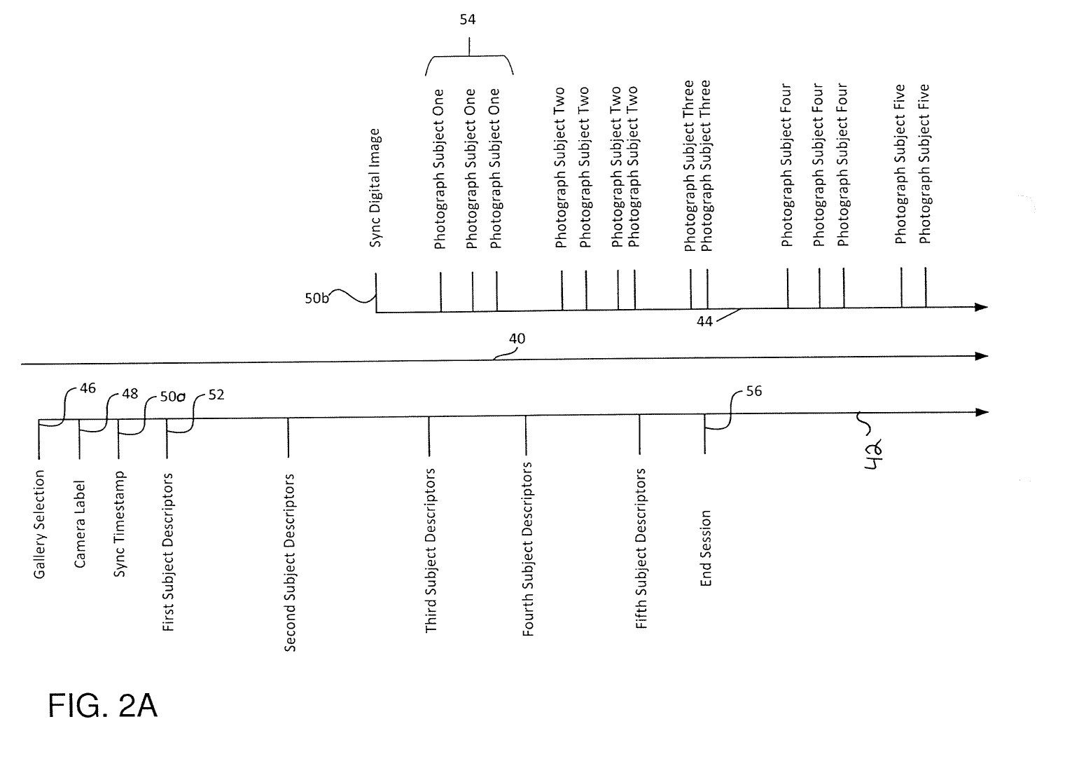

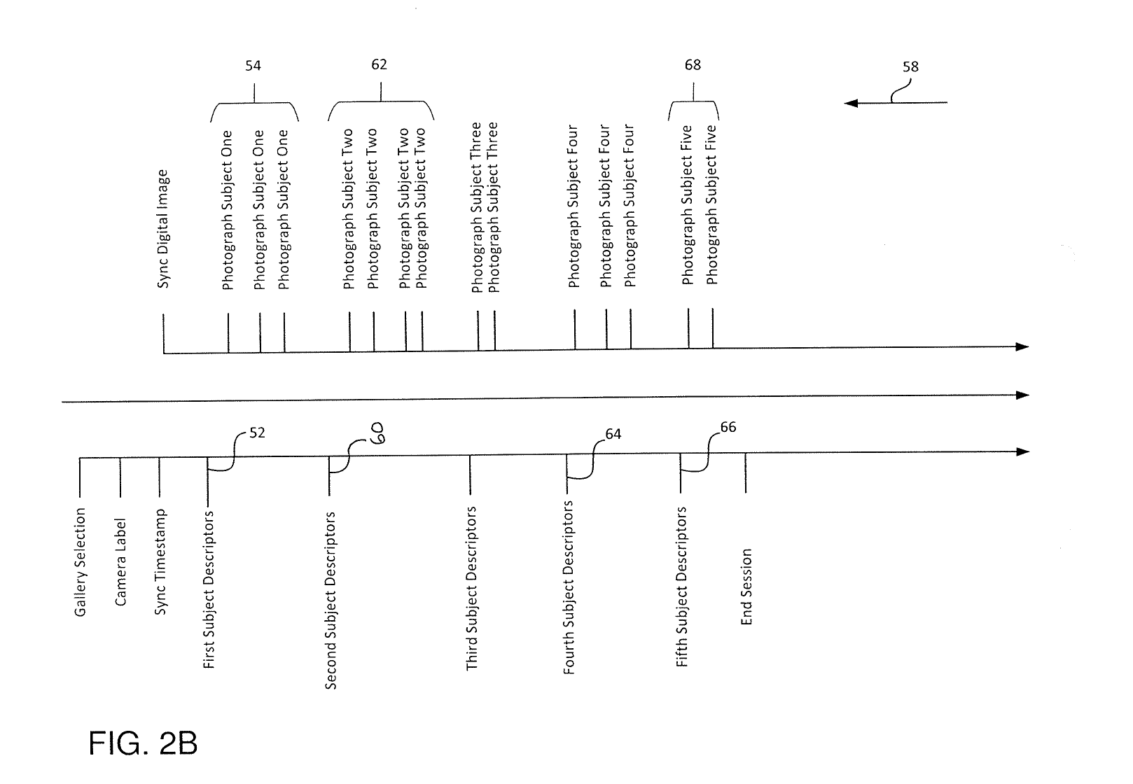

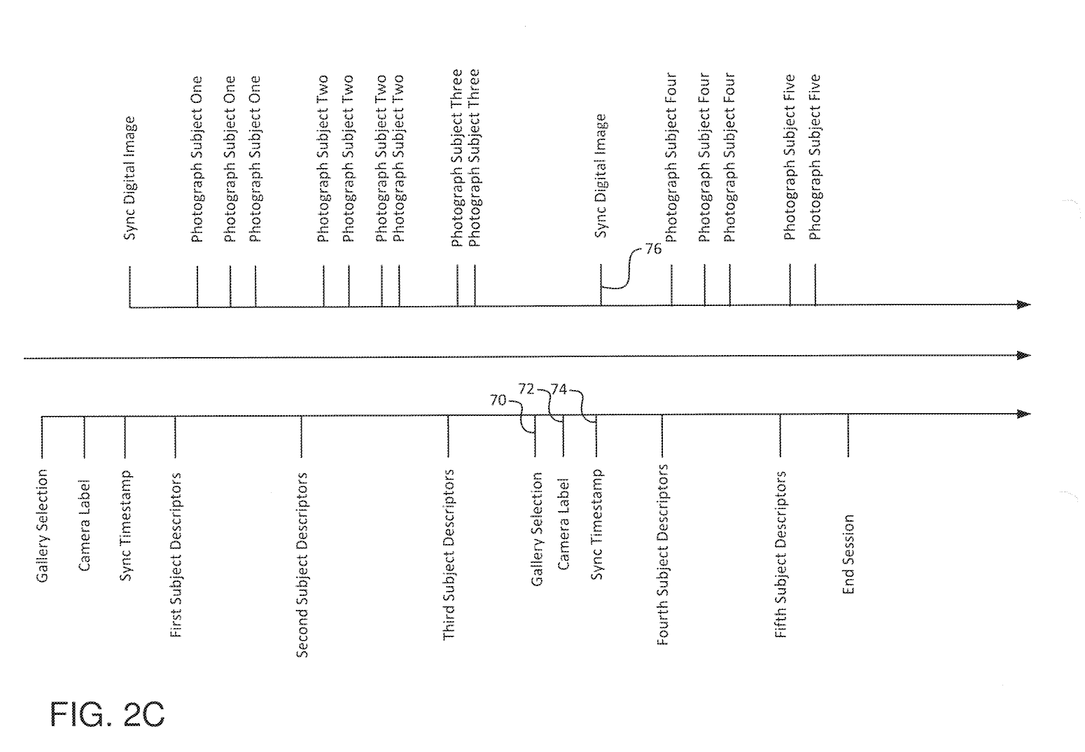

Once the digital images are captures, an image timeline is created representing the temporal order in which the digital sync image and the digital images were taken. The arrangement of the subject descriptors with the sync timeline can be arranged in temporal order and define a subject timeline such as shown as 42 in FIG. 2A. The computer readable instructions of the server can interlace the subject timeline and image timeline. The subject timeline and the image timeline can be sequentially realigned according to the synchronizing offset so that the proper temporal order of the subject descriptors and the digital images is provided. Once the subject timeline and the image timeline are sequentially realigned, the subject descriptors can be associated with one or more digital images matching the subject descriptor. The digital images with the assigned subject descriptors can be transmitted to a fulfillment computer system configured to produce digital image goods transmitted to the purchaser.

In one embodiment, the set of server computer readable instructions are configured to: receive a second image timeline, calculate a synchronizing offset between the sync timestamp and the sync digital date and time, calculate a second synchronizing offset between the sync timestamp and a second sync digital date and time included in the second image timeline, interlace the subject timeline, image timeline and second image timeline and sequentially realigning the subject timeline with the image timeline and second image timeline according to the synchronizing offset and second synchronizing offset, assign subject descriptors in temporal order with digital images according to the realigned interlaced subject timeline, image timeline and second image timeline, and, transmit the digital images with assigned subject descriptors to a fulfillment computer system configured to produce digital image goods transmitted to the purchaser.

Subsequently, a user can access the server using user computer system 32 and retrieve the images associated with a subject descriptor. The user can then select to purchase prints of the selected images. In one embodiment, a fulfillment service 33 can transmit to the server various goods that can be purchased with the image. For example, photographs, cups, t-shirts, mouse pads, plaques, and the like. Each good can be associated with a price to provide to the purchasing individual. The individual can then purchase and pay for the good. Once the images are selected for purchase, the image can be transmitted by the server to the print fulfillment service where the image can be converted into a physical form 35 which can then be transmitted to the user.

In one embodiment, the server can use contact information contained in the subject descriptor and transmit a notification to the individual informing the individual that the digital images of the subject are ready for viewing. In one embodiment, the server or print fulfillment service can inform the individual that the physical good has been shipped. In one embodiment, the digital image is not transmitted to the fulfillment service until payment is received. Once payment is received, it can be transmitted by the server to an account designated by the photographer.

Therefore, this invention allows for digital images to be quickly and efficiently uploaded to the server, associated with subject descriptors and subject descriptors, made available for purchase, search, and transmitted to a print fulfillment or print shop without post-processing by the photographer. The photographer merely uploads the digital images and the information from the remote computing device (smart phone) and the remainder of the process is automated.

Referring to FIG. 2A, the relationship between the physical representation of the physical activities of the photographer for recording the physical actions taken at the physical location of the photo-shoot and the images captured by the photographic subject is shown. The passage of time is represented by the timeline 40. The physical steps taken by the photographer for organizing the photographic images is shown as the subject timeline 42 and the temporal relationship of the actual images is shown as the image timeline 44. When the photographer arrives at the photo-shoot, the photographer selects a particular gallery at 46. In one embodiment, a list of galleries is retrieved from the server and displayed to the photographer so that the photographer can select the proper gallery. In one embodiment, the gallery information can be entered by the photographer in the event that the gallery information is not provided or otherwise not available.

At 48, the photographer selects the camera label. The camera label is a camera identifier that uniquely identifies a particular camera that is being used by the photographer. In some photo-shoots, there are multiple photographers taking images of photographic subjects that share the same gallery. For example, when shooting school photographs, the gallery may be for the entire school with different photographers shooting different images of students in different classes simultaneously. Once the camera label is selected, the photographer then actuates the smart phone application to capture the date and time stamp at 50a. Simultaneously, the photograph also takes a synchronization image 50b with the camera which results in an initial sync image having a date and time stamp. At 52, the photographer selects the first photographic subject to be photographed. At 54, the photographer takes one or more photographs of the first subject. It is also possible for the photographer to select the second subject without taking photographs of the first subject in the event of an absent photographic subject. In one embodiment, the subject descriptors are retrieved from the smart phone from the server and presented to the photographer for selection. This process can be repeated for multiple subjects. At 56, the photographer can indicate that the photograph session is completed. This indication is received by the smart phone and can be transmitted either in real time or subsequent to the photo-shoot to the server along with the gallery selection, camera label, sync timestamp and subject indicators. The set of images, including the synchronization image, can be transmitted to the server.

Once the information above is transmitted to the server, the photographer, or other individual, can review the information and have the sync timestamp and sync image date and time information displayed. A delta can be calculated between the sync timestamp and the sync image date and time information. Using this delta, the date and time information of the sync image and the digital images themselves can be adjusted and aligned with the date and time information of the subject matter identifiers.

Referring to FIG. 2B, the image timeline is shown shifted in a temporal direction 58 along the timeline so that the sync timestamp of the subject timeline aligns with the sync image of the image timeline. Creating this physical relationship between the actions of the photographer in selecting subject descriptor and capturing the image of the subject allows the subject descriptor to be associated with one or more images. In this example of the invention and process, the first subject descriptor is selected earlier in time than the captured first image. Therefore, it is known that the images 54 are associated with the subject descriptor 52. It is also known that the images are associated with a particular gallery. When the photographer selects the second subject descriptor 60, it is known that the images 62 are associated with the second subject descriptor as they fall between the date and time stamp of the second subject descriptor and the third subject descriptor.

According to this invention, the functionality of the service is improved in that the captured digital images can be associated with a subject descriptor even when the date and time information of the smart phone is not sync′d with the date and time of the server or camera. Further, field of associating digital images with galleries and subject matter identifier is improved and reduces the time and energy expended in an attempt to match subject matter identifier with captured digital images.

According to the present invention, it is not necessary for the photographic subjects to be in a certain order nor it is necessary to capture all the images in a linear fashion. For example, at 64, the photographer indicates that the fourth subject is the next set of images to capture. However, the subject is absent or otherwise not available for photographs. Therefore, the photographer selects the fifth subject at 66 and the images 68 can be associated with this subject.

Referring to FIG. 2C, the flexibility and error correcting aspects that improve the current start of the art and technological field is shown. In the event a camera ceases to be operational, such as after the third subject is photographed in this example, the photographer can obtain a new camera, select the gallery at 70, select a camera label for the new camera at 72, capture a second sync timeline at 74 and take second sync image at 76 and continue to photograph subjects.

In one embodiment, the sync image is an image taken with the lens cap on so that image is black or near black. The server computer readable instructions can then determine that the black or near black image is the sync image to use the associated date and time stamp with the sync digital image. When images are captures, they can be arranged in temporal order so that the sync digital image and set of digital images define a image timeline as shown in FIG. 2A as 44.

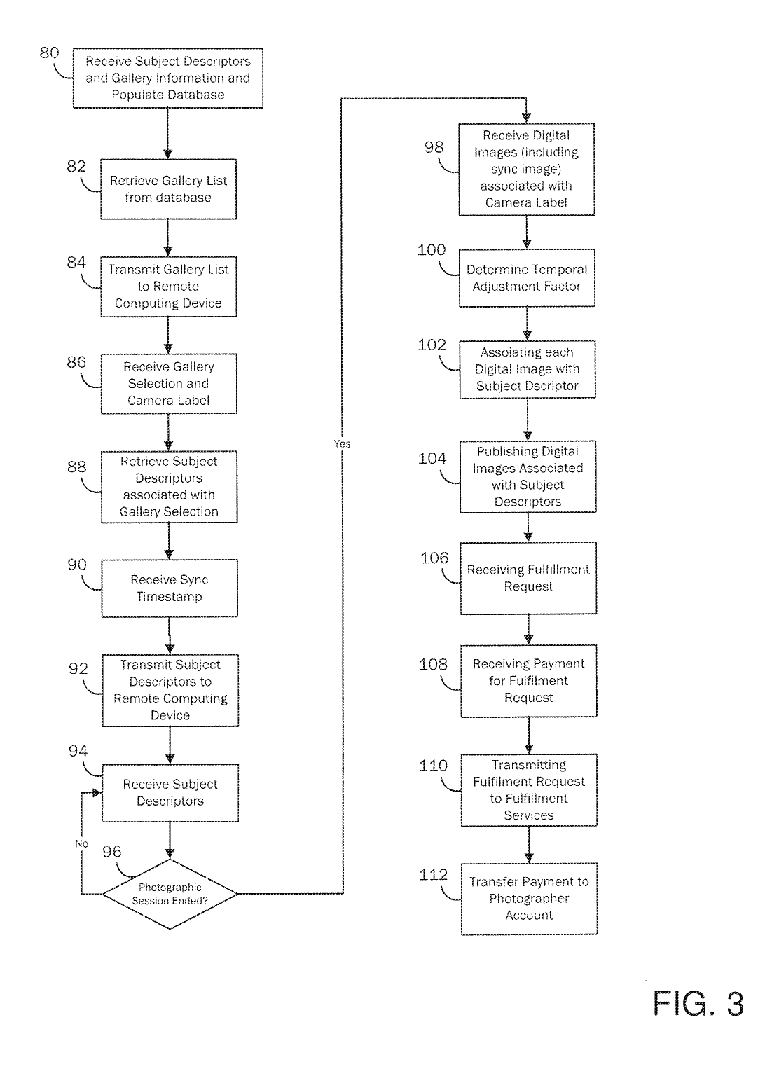

Referring to FIG. 3, the process and functionality of the server that illustrates the invention adds substantially more than the operation of the general computer and above and beyond conventional computer operations. Further, the technology in the field of matching images with subject matter identification is improved and the traditional problem of efficiently and automatically associated images with subject information has been solved. At 80, the list of subject descriptors and the associated gallery is placed in a database as it is received from a source such as a school. When the photographer wishes to start taking photos of subjects, the remote computing device, such as a smart phone with an app, the photographer requests the gallery list from the server at 82 and it is transmitted at 84. The gallery list is displayed to the photographer at 86 so that the photographer can select the gallery that the photographer wishes to work with at 86. The camera label, identifying the camera to be used, is captured by the remote computing device at 86 as well. The server then retrieves the subject descriptors associated with the selected gallery at 88. The photographer then creates a sync timestamp at 90. The subject descriptors are transmitted to the remote computer device from the server at 92 and displayed on the remote computer device. The photographer indicates using the remote computer device that the first subject descriptors will be the subject of the next digital images. When the images are taken of the first subject, the photographer selects the next subject descriptor and takes images of that subject. The subject descriptors selected by the photographer can be transmitted to the server at 94 real time or can be transmitted in a batch after the photographic session is completed. If more subject matter descriptors exist at 96, the invention returns to 94 otherwise the invention continues where the digital images are uploaded to the server at 98.

The temporal synchronizing offset is calculated at 100. Using the synchronizing offset on the timestamps of each digital image, the images are associated with the proper subject descriptor at 102. The images are then published for review such as on a website of the global communication network at 104.

The server can receive a request for fulfillment at 106 and payment for the fulfillment request at 108. The digital image selected can be transmitted to a fulfillment service at 110 and payment can be transferred to the photographer at 112. Notifications can alert each individual, using the individual's contact information that can be contained in the subject descriptors, at 104 when the images are published.

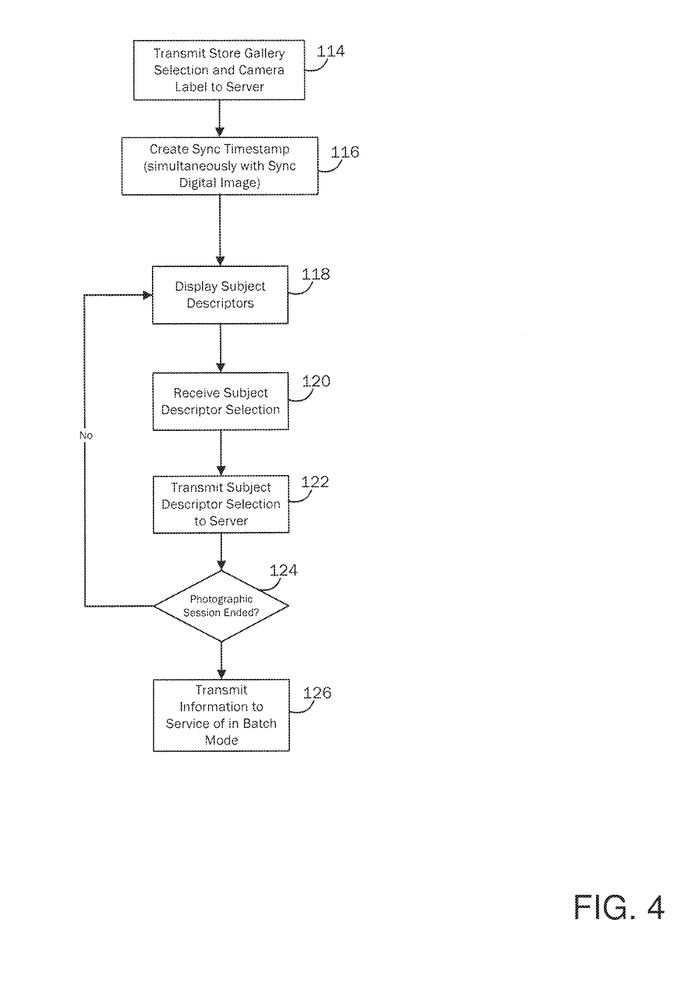

Referring to FIG. 4, the remote computer device (smart phone in one case), transfers the camera label and gallery selection to the server at 114. A sync timestamp is created at 116 that can be performed simultaneously with the creation of a sync digital image. The subject descriptor can be selected at 120 after being displayed at 118 and once selected can be transmitted to the server at 122. If additional subject descriptors remain at 124, the invention can return to 118. If the gallery selection, camera label, sync timestamp and subject descriptors are transmitted in batch mode, it can occur at 126.

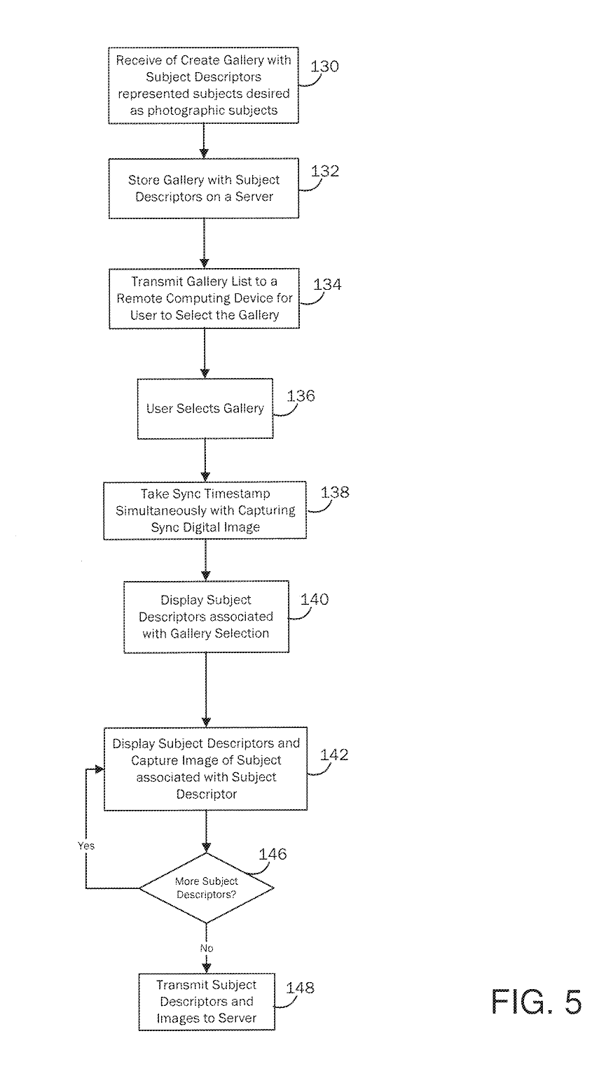

Referring to FIG. 5, the operation of the invention is shown in more detail and particularly how technology in the field of matching images with subject matter identification has improved. A gallery having subject descriptors is created at 130. This can be a list of students for school photographs, team members for a sports team, employee headshots for marketing collateral and the like. The gallery and the associated subject descriptors can be stored on a server at 132. A list of galleries can be transmitted to a remote computing device so that when the photographer selects the gallery, the selection can be transmitted back to the server and the list of subject descriptors that are associated with the gallery are transmitted to the remote computing device. In one embodiment, the remote computing device accesses the server through a web browser to have information from the server displayed to the user of the remote portable device such as through a URL. Once the list of galleries is displayed at 143, the photographer can select which gallery to work with at 136. Once the gallery is selected, a sync timestamp can be captured at 138 and the list of subject descriptors is displayed for the photographer at 140. Images are then captured for the selected subject descriptor at 142. If there are more subject descriptors in the list at 146, the invention returns to 144, otherwise, the subject descriptions, digital images and other information is transmitted to the server at 148.

Smart Price Sheet

Once the images are uploaded to the server after the photographic session and the images are associated with the proper subject identifier, the photographer can provide the images for review by potential customers for online purchases. The digital images can be downloaded by the customer, prints can be created and provided to the customer, photographic service (editing) can be provided to the customer or other goods that can include the digital image or images can be provided to the customer. The photographer collaborates with third party vendors to provide certain goods and services including the vendor of the online platform providing this functionality.

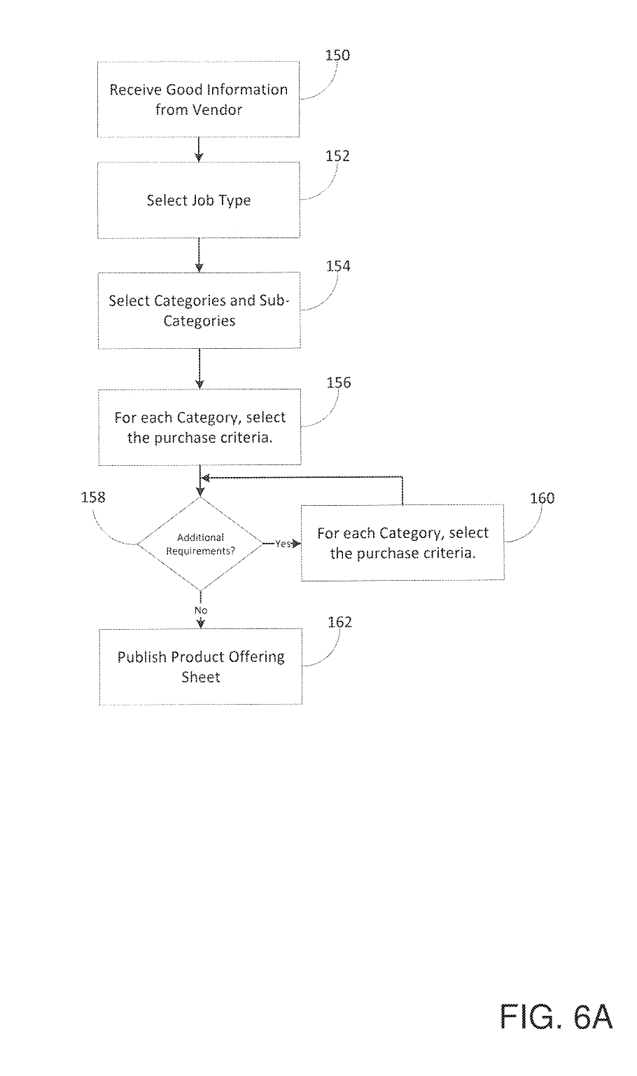

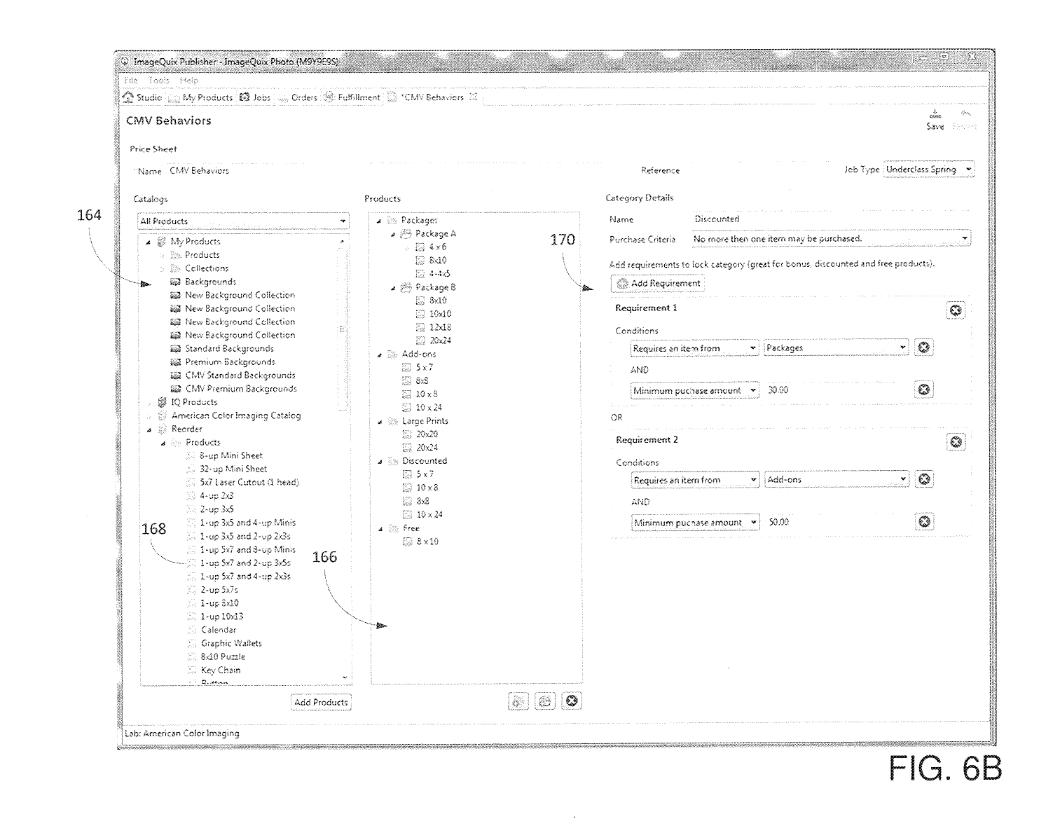

Prior to offering the third party goods, the photographer must receive information related to the goods from the third party. Referring to FIG. 6A, step 150 is where the third party vendor information is received and can be stored on the server. The information that is provided by the third party can include the third party vendor name, address, email account, and product list with pricing and the like, that can be stored on the server. The computer readable instructions can display the name of third party vender; goods and pricing with an icon representing that the goods are from the third party. The photographer selects a job type to identify the product offering (price sheet) that will be displayed to the customer. The job type allows the photographer to create customized product offerings for each school, grade, class, or individual. Additionally, the product offering can be specific for different events, times of year, or other criteria at the photographer's discretion.

For each job type, the photographer can select categories and sub-categories of goods offered at 154. For example, one category could be Packages with two sub-categories of Package A and Package B. The specific goods and quantity offered within the package can be shown such as 1-4×6 representing one photograph that is 4 by 6 inches in size. Once selected, the goods can be displayed in a Products area of the screen designated that the goods can be purchased. The goods can be selected from a list of all products independently of the vendor providing the good.

In one embodiment, each category can include details that can be customized by the photographer to provide purchasing rules. Purchasing criteria can be selected at 156 and can include options such as not allowing the selection of more than one item per for a Discounted Category. If the photographer wants to add additional requirements at 158, the additional requirements can be added at 160. There can be multiple requirements such as (a) the customer must select at least one item from the packages and (b) the purchase amount must be a minimum of $30.00. The photographer can determine that if the total purchase price is greater than a certain amount, a digital image of the photograph will be provided at no charge to the customer. Once the product offering is completed, it can be published online for the customer and potential customer associated with the photographic session to view and purchase goods.

In one embodiment, FIG. 6B shows the interface screen displayed to the photographer for the creation of the product offering. The listing of all the potential products is shown in a screen 164. The photographer can elect a good and drag it into the Products area 166. Each good can have an associated source icon 168 that can designate the source of the goods. For example, the yellow icon can represent that the good is provided from a third party vendor. The green icon can represent that the good is provided directly from the photographer. The category details can be displayed and managed from the screen shown generally as 170.

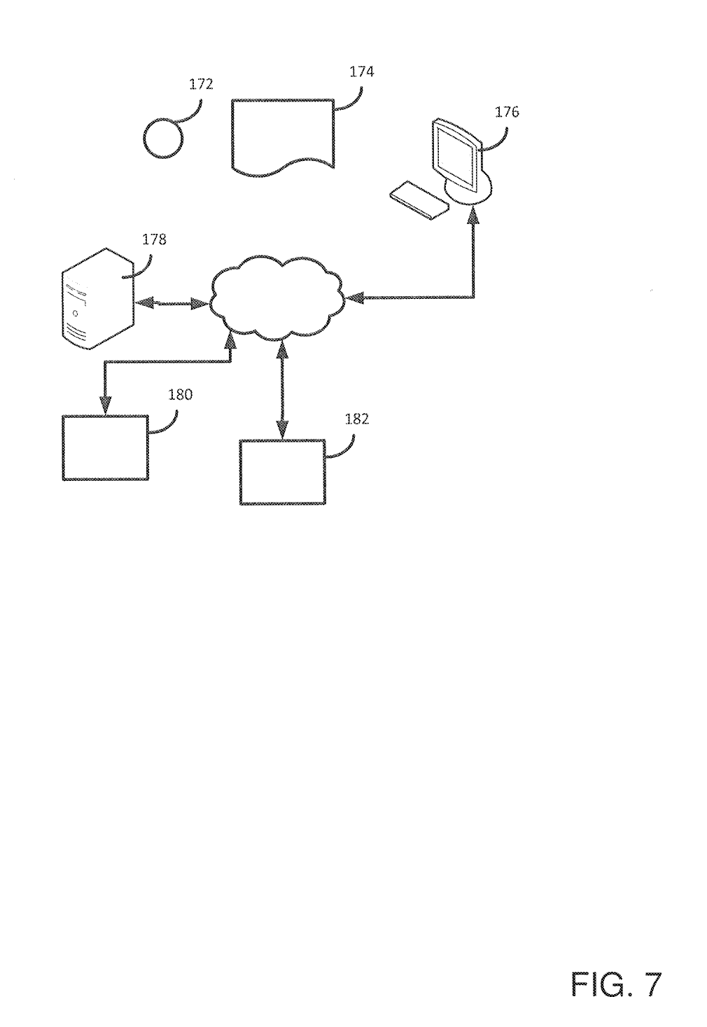

Referring to FIG. 7, the operation is shown in further detail. The potential customer 172 is provided with a link such as URL 174 where the potential customer can provide access information using computer 176 and access the product offering associated with that potential customer. The potential customer can be associated with, for example, a specific school, grade, class, and student so that only the student's parents can view the digital images of the individual and potentially the class image. The server 178 receives the request for access and retrieves the product offering (Smart Price Sheet) and display the product offering to the customer. The potential customer selects goods for purchase and can provide payment information that can be processed through a third party clearing house 180. The clearing house can receive payment information, verify payment, and transmit verified payment information to the server, so that the goods can be processed for distribution to the customer. In one embodiment, a commission from the server operator can be deducted from the payment prior to providing funds to the photographer.

The set of server computer readable instructions are configured to: receive purchaser user information representing a potential purchaser of digital goods or services, associate a gallery to the purchase user information, associate a subject descriptor to the user representing a digital image subject, and, transmitting to a purchaser's computer digital images and goods and services associated with the digital images matching the gallery and subject descriptor associated with the purchaser. The set of server computer readable instructions are configured to: receive fund information represent funds to be received from the purchaser, calculate a predetermined portion of the fund total from the total amount received from the purchaser, and, transmit the fund information less the predetermined portion of the fund total to the fulfillment computer system. The set of portable computer readable instructions are configured to: receive goods information from the server, display goods for purchase to the user associated with the selected subject descriptor, receive purchase information from the user, and, transmit the purchase information to the server.

Once payment is verified, the computer readable instructions on the server can transmit ordering information to a third party vendor for the goods ordered, with payment information, for fulfillment. Payment can be transmitted electronically to the third party vendor in one embodiment. The vendor can then manufacture the goods and provide verification to the server that the goods have been shipped.

The computer readable instructions provides for dynamic creation and application of purchasing rules (purchasing criteria) that include: no items are required to be selected, only one item may be selected, only one item must be selected and at least one item must be selected. The job type can allow for multiple rules to be put in place based upon any number of criteria including gallery, new or returning customer, and time of year, event (sporting, school, etc.) and the like.

Smart Work Flow

Generally, the computer readable instructions can be described in three portions that are integrated into a seamless process for the scheduling, capturing, management, and distribution of digital images and digital image goods: Setup, Capture, and Launch.

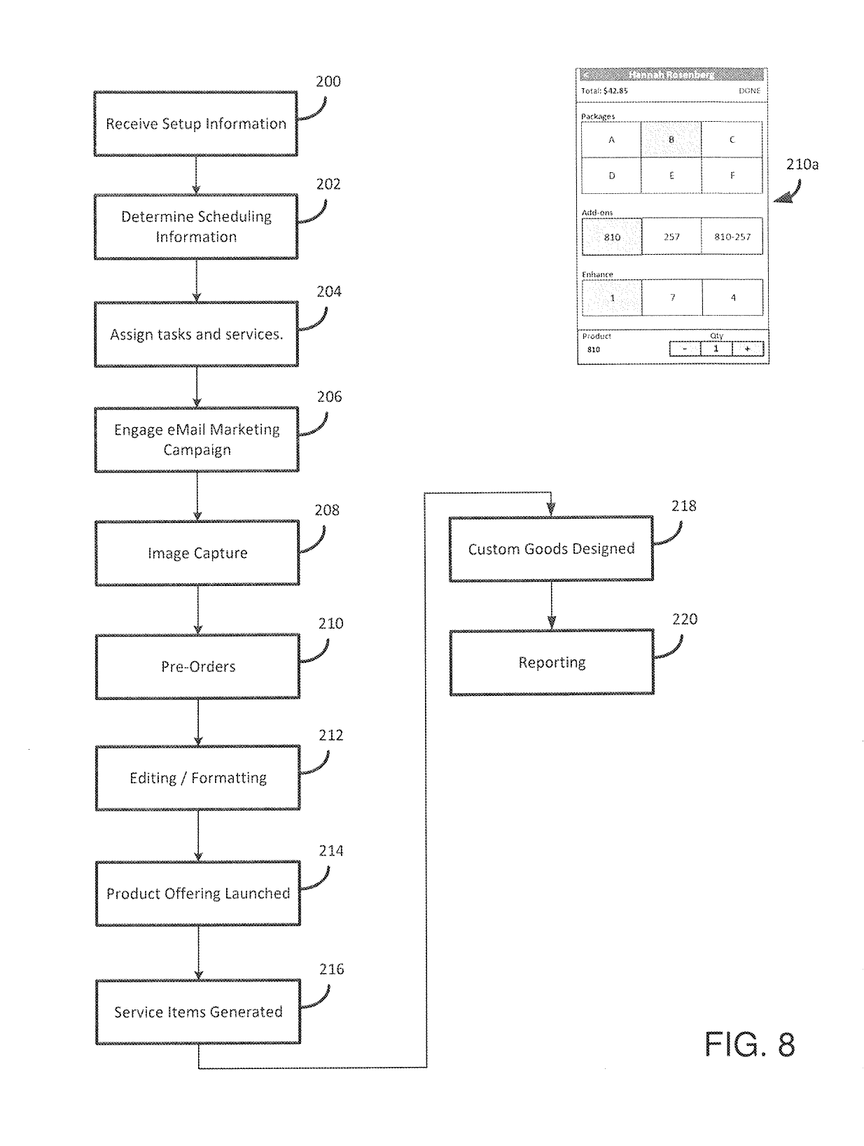

A photographic job involves many aspects in the logistics and implementation of performing the job. First, the job must be setup correctly. This setup includes the services that are needed for the job including data collection. Referring to FIG. 8, the scheduling of the job is accomplished. The computer readable instructions receive setup information at 200. The setup information can include the event, entity, entity information, service to be provided and any special goods to be offered. Scheduling can then be determined at 202 to include the date for capturing images, retake day and the like. The schedule should contemplate the services offered. For example, the yearbook publication date would affect delivery of digital images and should be considered when setting the scheduling. An email campaign to drive potential customer to the online purchasing can be included in the original job setup and scheduling allowing these activities to be tied to the job itself.

Once the job is created and scheduled, the customer can use the computer readable instructions to access appointment scheduling, payments and even receive print credits that can be applied for subsequent print purchases. During the setup and scheduling portion of the invention, production services can be selected and assigned. For example, if the customer for the job wants a DVD created or a yearbook CD created, these requests can be included in the job setup information.

With a job, various tasks associated with the job can be included at 204. For example, the job may include the creation of a data CD. If this is the case, the task, owner of the task and the status of the task can be included in the job creation information. This type task can be classified as a Client Service and performed by the photographer or vendor. Other services can include a yearbook CD, proof sheets, mug sheets, and the like. There can be additional services that can be performed that include image selection, cropping, green screen knockouts, color enhancements, email marketing campaign, and the like. Such services can be classified as Studio Services and selected and assigned when the job is created.

When the job is setup, emails of potential clients can be included with the job. For example, if the job is school photographs, email address of the parents can be included with the job to provide information about image availability, goods available, pricing and delivery dates, in advance of the actual ordering process.

The product offering can also be created at the job creation of subsequently, based upon the preferences of the photographer. In the event there is a marketing campaign associated with the job at 206, the photographer has the ability to communicate specials, as well as, offering to potential customers in advance of the ordering process.

During the image capture process at 208, goods can be offered contemporaneously and pre-order information captured at 210. For example, the smart phone can display the screen shown as 210a. The screen display information retrieves product offering information associated with the job. For example, the photographer can select that the subject wishes to pre-order the B package, with the add-on designated 810 with enhancement 1. The quantity of each item can be included and the total price displayed at the top of the screen in real time. The photographer can then be in a conversation with the customer concerning purchasing decision at the time of the image capture. The header can show the subject identifier to insure that the pre-order information is associated with the proper subject identifier.

In one embodiment, a second smart phone or tablet or other portable device can be used to show the subject product offerings allowing for pre-order information to be received at the image capture stage. The second smart phone or table can be in communication with the server and retrieve the data to display to the subject. Once selected, the pre-order information can is uploaded to the server and accessible remotely.

When the image capture is completed, editing can be performed at 212 for such actions as green screen knock-out, conversation from jpeg to png, removing “bad” images, and the like.

Once the images are captured and associated with subject identifiers, the job distribution (product offering) can be launched at 214. The job is published for online review and ordering. This is seamless due to the data and image capturing occurring with centralized storage and the interrelationship between the data and the images on the server. Part of the job distribution includes service items being automatically created and transmitted to the proper customer at 216. For example, if the entity commissioning the job requests a yearbook CD, the yearbook CD can be generated and distributed to the school. Additionally, pre-orders are released and transmitted to the appropriate vendor for fulfillment and distribution to the customer. With the previously captured data, these tasks can be automated. Additionally, the email marketing can be launched with preconfigured email scheduled based upon the campaign that is created with job.

Once the job is launched, the customer can use the interface provided by the computer readable instructions and customize or configure goods for purchase. For example, multi-node goods can be designed and ordered at 218. Once designed, the good can be sent for fulfillment. In the configuration information, the goods ordered can be automatically sent to the proper vendor for fulfillment.

Reporting can be included at 220 for an analysis of such information and data points as job revenues, profitability, product popularity, and buy-rates.

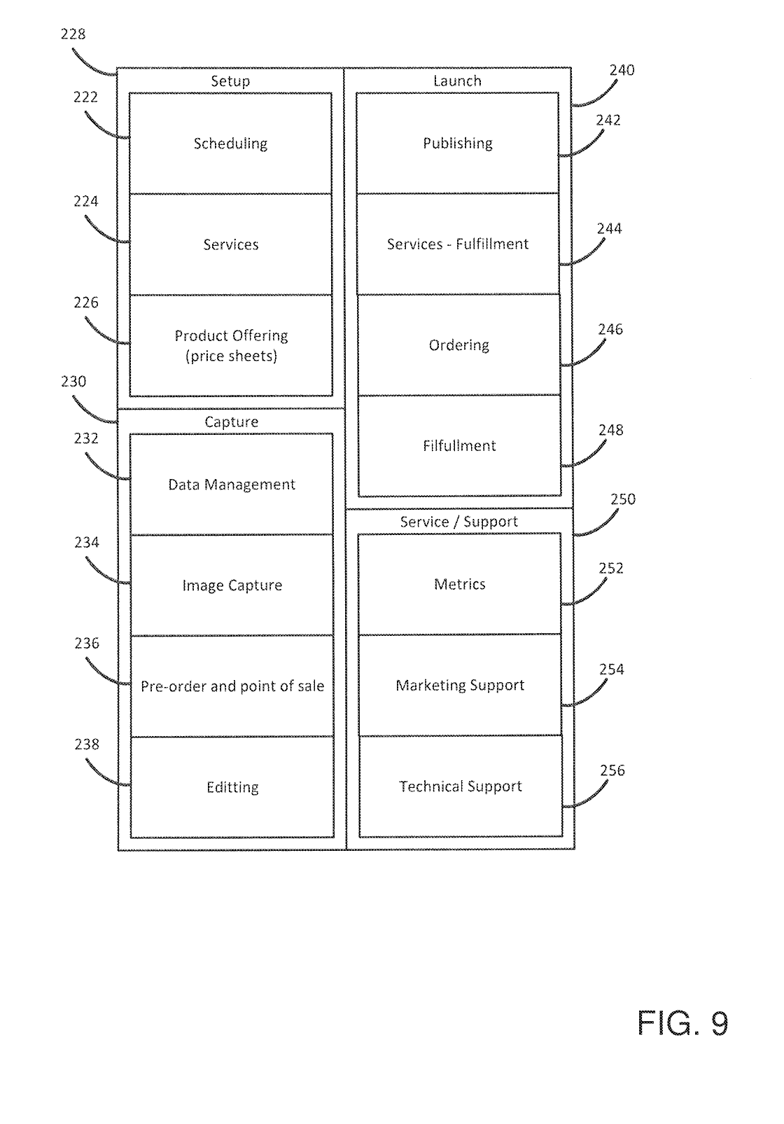

Referring to FIG. 9, components of the computer readable instructions are shown providing the structure and functionality of the present invention. Scheduling is shown as 222 and provides for the photographer to schedule the image capture, retakes, email campaign, delivery of certain service items, launch dates and the like. Services at 224 include the ability to select and edit the services associated with the job such as yearbook CDs and the like. Product offering (price sheets) 226 can be established as part of the setup 228.

The capture portion 230 can include data management 232 allowing the data to be shared between the server, smart phone, remote access and various databases to allow for the seamless and efficient workflow. The image capture portion is shown as 234 and described herein. The pre-order portion can be included at 236 allowing point of sale functionality during image capture. Any editing can be performed with portion 238.

The launch portion 240 is shown and can include publishing at 242. Any automatic services or fulfillment can be launched at 244. The customer can place the order, including the creation of customized goods using the ordering portion 246. The goods ordered are fulfilled using the fulfillment portion 248.

During the process, the photographer can use the service and support portion 250 and receive reporting with portion 252, marketing support with portion 254 and technical support with portion 256.

When a job is created, the data received typically needs to be modified for corrections, errors, formatting issues, and the like. During the data importation process, the photographer can include action item information with the data as it is imported and not after the fact so that then integrity of the job data is intact at the outset of the job creation.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A computer-implemented system for capturing, managing, storing, and distributing goods and services related to photographic digital images, the system comprising:
a server having a computer readable medium and a processor;
a set of server computer readable instructions that, when executed by the processor, are configured to:
receive a set of subject descriptors from an originating remote computer in communications with the server wherein the set of subject descriptors include properties taken from a group consisting of: name; school; grade; class; teacher; and any combination thereof,
create gallery information representing different photographic jobs,
associate each subject descriptor with a particular gallery,
receive a sync digital image having a sync digital date and time created from a digital image capturing device, stored on a digital image capturing device media and receive a set of digital images each having a digital image timestamp wherein the sync digital image and set of digital images are configured in temporal order to define an image timeline,
receive a portable sync timestamp and a set of subject descriptors selection information from a portable computer device,
calculate a synchronizing offset between the sync timestamp and the sync digital date and time,
interlace the subject timeline with the image timeline and sequentially realigning the subject timeline with the image timeline according to the synchronizing offset,
assign subject descriptors in temporal order with digital images according to the realigned interlaced subject timeline and image timeline,
transmit the digital images with assigned subject descriptors to a fulfillment computer system configured to produce digital image goods transmitted to the purchaser;
the portable computer device having a portable processor and a set of portable computer readable instructions that, when executed by the portable processor, are configured to:
receive a listing of galleries from the server,
display the list of galleries to a photographer,
receive a gallery selection from the photographer,
receive a subset of subject descriptors associated with the selected gallery,
display at least a portion of the subset of subject descriptors to the photographer,
capture the portable sync timestamp,
receive a set of subject description selection information from the photographer having descriptor selection timestamp,
transmit the portable sync timestamp and the subject description selection information to the server; and,
wherein the subject timeline is defined by the portable sync timestamp and set of subject descriptor selection information configured in a temporal arrangement.

2. The system of claim 1 wherein the set of server computer readable instructions are configured to:
receive a second image timeline,
calculate a synchronizing offset between the sync timestamp and the sync digital date and time,
calculate a second synchronizing offset between the sync timestamp and a second sync digital date and time included in the second image timeline,
interlace the subject timeline, image timeline and second image timeline and sequentially realigning the subject timeline with the image timeline and second image timeline according to the synchronizing offset and second synchronizing offset,
assign subject descriptors in temporal order with digital images according to the realigned interlaced subject timeline, image timeline and second image timeline, and,
transmit the digital images with assigned subject descriptors to a fulfillment computer system configured to produce digital image goods transmitted to the purchaser.

3. The system of claim 1 wherein the set of server computer readable instructions are configured to calculate the synchronizing offset by converting the sync timestamp and the sync digital date and time into POSIX and calculating the difference between the sync timestamp and the sync digital date and time.

4. The system of claim 1 wherein the set of server computer readable instructions are configured to:
calculate brackets between adjacent subject descriptors, and,
assign subject descriptors in temporal order with digital images according to the realigned interlaced subject timeline, image timeline and the brackets.

5. The system of claim 1 wherein the set of server computer readable instructions are configured to:
receive a fulfillment request from a user, and,
transmit the fulfillment request to the fulfillment computer system.

6. The system of claim 1 wherein:
the sync digital image is a digital image that is nearly black;
wherein the set of server computer readable instructions are configured to detect a nearly black digital image and determine the sync digital date and time from the nearly black digital image.

7. The system of claim 1 wherein the set of server computer readable instructions are configured to:
receive purchaser user information representing a potential purchaser of digital goods or services,
associate a gallery to the purchase user information,
associate a subject descriptor to the user representing a digital image subject, and,
transmitting to a purchaser's computer digital images and goods and services associated with the digital images matching the gallery and subject descriptor associated with the purchaser.

8. The system of claim 7 wherein the set of server computer readable instructions are configured to:
receive fund information represent funds to be received from the purchaser,
calculate a predetermined portion of the fund total from the total amount received from the purchaser, and,
transmit the fund information less the predetermined portion of the fund total to the fulfillment computer system.

9. The system of claim 1 wherein the set of portable computer readable instructions are configured to:
receive goods information from the server,
display goods for purchase to the user associated with the selected subject descriptor,
receive purchase information from the user, and,
transmit the purchase information to the server.

10. A computer-implemented system for capturing, managing, storing, and distributing goods and services related to photographic digital images, the system comprising:
a server having a computer readable medium and a processor;
a set of gallery information stored on the computer readable medium wherein each gallery includes a set of subject descriptors stored on the computer readable medium;
a set of server computer readable instructions that, when executed by the processor, are configured to:
receive a sync digital image having a sync digital date and time created from a digital image capturing device and stored on a digital image capturing device media,
receive a set of digital images stored on a digital image capturing device media each having a digital image timestamp wherein the sync digital image and set of digital images are configured in temporal order to define an image timeline,
receive a portable sync timestamp and a set of subject descriptor selection information from a portable computer device,
calculate a synchronizing offset between the sync timestamp and the sync digital date and time,
receive a subject timeline defined by the portable sync timestamp and set of subject descriptor selection information configured in a temporal arrangement,
interlace the subject timeline with the image timeline and sequentially realigning the subject timeline with the image timeline according to the synchronizing offset,
assign subject descriptors in temporal order with digital images according to the realigned interlaced subject timeline and image timeline,
transmit the digital images with assigned subject descriptors to a fulfillment computer system configured to produce digital image goods transmitted to the purchaser.

11. The system of claim 10 wherein the set of server computer readable instructions are configured to:
receive a second image timeline,
calculate a synchronizing offset between the sync timestamp and the sync digital date and time,
calculate a second synchronizing offset between the sync timestamp and a second sync digital date and time included in the second image timeline,
interlace the subject timeline, image timeline and second image timeline and sequentially realigning the subject timeline with the image timeline and second image timeline according to the synchronizing offset and second synchronizing offset,
assign subject descriptors in temporal order with digital images according to the realigned interlaced subject timeline, image timeline and second image timeline.

12. The system of claim 10 wherein the set of server computer readable instructions are configured to:
calculate synchronizing offset by calculating the difference between the sync timestamp and the sync digital date and time, and,
normalize the digital image timestamp of each digital image included in the image timeline to sequentially realigning the subject timeline with the image timeline.

13. The system of claim 10 wherein the set of server computer readable instructions are configured to:
calculate brackets between adjacent subject descriptors, and,
assign subject descriptors in temporal order with digital images according to the realigned interlaced subject timeline, image timeline and the brackets.

14. The system of claim 13 wherein the brackets are defined as the difference between the descriptor selection timestamp of one of the subject descriptors and a value less than the timestamp of an adjacent subject descriptors.

15. The system of claim 10 wherein:
the sync digital image is a digital image that is nearly black; and,
wherein the set of server computer readable instructions are configured to detect a nearly black digital image and determine the sync digital date and time from the digital image that is nearly black.

16. The system of claim 10 wherein the set of server computer readable instructions are configured to:
display fulfillment options to a user,
receive a fulfillment request from the user, and,
transmit the fulfillment request to the fulfillment computer system.

17. A computer-implemented system for capturing, managing, storing, and distributing goods and services related to photographic digital images, the system comprising:
a server having a processor and in communications with a computer readable medium;
a set of gallery information stored on the computer readable medium representing different photographic jobs wherein each gallery includes a set of subject descriptors wherein the set of subject descriptors include properties taken from a group consisting of: name; school; grade; class; teacher; and any combination thereof,
a set of server computer readable instructions that, when executed by the processor, are configured to:
receive a sync digital image having a sync digital date and time created from a digital image capturing device, stored on a digital image capturing device media and receive a set of digital images each having a digital image timestamp wherein the sync digital image and set of digital images are configured in temporal order to define an image timeline,
receive a portable sync timestamp and a set of subject description selection information from a portable computer device,
calculate a synchronizing offset between the sync timestamp and the sync digital date and time,
interlace the subject timeline with the image timeline and sequentially realigning the subject timeline with the image timeline according to the synchronizing offset,
assign subject descriptors in temporal order with digital images according to the realigned interlaced subject timeline and image timeline,
transmit the digital images with assigned subject descriptors to a fulfillment computer system configured to produce digital image goods transmitted to the purchaser;
the portable computer device having a portable processor and a set of portable computer readable instructions that, when executed by the portable processor, are configured to:
receive a listing of galleries from the server,
display the list of galleries to a user,
receive a gallery selection from the user,
receive a subset of subject descriptors associated with the selected gallery,
capture the portable sync timestamp,
(a) display at least a portion of the subset to the user,
(b) receive a set of subject description selection information from the photographer,
repeat (a) and (b) until end session information is received from the user,
transmit the portable sync timestamp and the subject description selection information to the server; and,
wherein the subject timeline is defined by the portable sync timestamp and set of subject descriptor selection information configured in a temporal arrangement.

18. The system of claim 17 wherein the set of server computer readable instructions are configured to:
receive a second image timeline,
calculate a synchronizing offset between the sync timestamp and the sync digital date and time,
calculate a second synchronizing offset between the sync timestamp and a second sync digital date and time included in the second image timeline,
interlace the subject timeline, image timeline and second image timeline and sequentially realigning the subject timeline with the image timeline and second image timeline according to the synchronizing offset and second synchronizing offset,
assign subject descriptors in temporal order with digital images according to the realigned interlaced subject timeline, image timeline and second image timeline.

19. The system of claim 17 wherein the set of server computer readable instructions are configured to:
calculate brackets between adjacent subject descriptors, and,
assign subject descriptors in temporal order with digital images according to the realigned interlaced subject timeline, image timeline and the brackets.

20. The system of claim 13 wherein:
the brackets are defined as the difference between the descriptor selection timestamp of one of the subject descriptors and a value less than the timestamp of an adjacent subject descriptors without an intervening digital image in the interlaced subject timeline and the image timeline.
